(19) United States
(12) Patent Application Publication
(10) Pub. No.: US 2014/0208406 A1
(43) Pub. Date: Jul. 24, 2014

(54) TWO-FACTOR AUTHENTICATION

(71) Applicant: N-DIMENSION SOLUTIONS INC., Richmond Hill (CA)

(72) Inventors: Charles Frederick AUSTIN, Markham (CA); Xingsheng WAN, Markham (CA); Andrew WRIGHT, Austin, TX (US)

(73) Assignee: N-DIMENSION SOLUTIONS INC., Richmond Hill (CA)

(21) Appl. No.: 13/748,153

(22) Filed: Jan. 23, 2013

(51) Int. Cl. G06F 21/31

(52) U.S. Cl. CPC G06F 21/31; H04L 63/02; H04L 63/0272
USPC 726/7

(57) ABSTRACT

Systems and processes for providing two-factor authentication to systems capable of implementing varying levels of access control are disclosed. The system may include an authentication and access control system that selectively grants access to a secured system or network. The authentication and access control system implements a two-factor authentication routine and may configure a firewall gateway to grant or deny access to the secured system or network based on the results of the two-factor authentication. A user may connect to the authentication and access control system via a VPN. By separating the user from the secured system or network, the authentication and access control system can provide two-factor authentication for the secured system regardless of the secured system's own cyber security capabilities. This is particularly useful for legacy systems in infrastructure operating environments that are incapable of implementing a more sophisticated access control protocol, such as two-factor authentication.

### BACKGROUND

1. Field

This application relates generally to authentication systems and, more specifically, to systems and processes for providing two-factor authentication to various types of systems in the infrastructure and critical infrastructure operating environments.

2. Related Art

Cyber security is a primary component of national security. As the infrastructure industries (e.g., utility, transportation, oil and gas, and other industries) adopt state of the art digital technology based on open standards, interne protocol (IP) networking, and wireless communications, it is important for infrastructure operators of all sizes and configurations to develop comprehensive cyber security plans to mitigate risks and vulnerabilities in their operations.

There are currently numerous access control protocols that can be used to provide cyber security to various devices and systems. For example, two-factor authentication is one popular practice that can be used to authenticate a user before granting access to a secured system. Two-factor authentication generally requires that a user provide two or more of a knowledge factor (e.g., something a user knows, such as a password, answer to a question, etc.), an inherence factor (e.g., something the user is, such as a fingerprint, retinal scan, other biometric data, etc.), and a possession factor (e.g., something the user has, such as a key, token, etc.). One common implementation example of two-factor authentication is a computer system that requires a user to provide a username/password and a numerical passcode generated from a nondeterministic random sequence (e.g., from a keyfob or an application running on a mobile device). By requiring the user to provide more than one piece of information, two-factor authentication systems provide additional security over more primitive single factor authentication systems.

While two-factor authentication has become popular for its ease of use and enhanced level of security, access control for many cyber assets (e.g., computer systems, databases, equipment, etc.) of the infrastructure industries are still relatively primitive. For example, some cyber assets in infrastructure industries include no access control, fixed user ID and/or fixed password, or single factor user ID and password control. The specific type of access control typically depends on the individual assets and their vintage. While it may be desirable to provide a higher level of access control to the cyber assets of the infrastructure industries, many of these assets are relatively old devices that cannot implement other types of access control protocols. For example, many of the legacy assets in the utility industry are so old that they cannot comply with the minimal cyber security requirements for access control as specified by the North American Electric Reliability Corporation (NERC) Critical Infrastructure Protection (CIP) program, which details the physical and cyber security requirements for the bulk power system of North America. As a result, many cyber assets of the infrastructure industries are left vulnerable to cyber-attack.

Thus, systems and processes for providing improved security for systems capable of implementing varying levels of access control are desired.

### SUMMARY

Systems, methods, and computer-readable storage medium for providing two-factor authentication for a secured system in an infrastructure operating environment are provided. In one example, a method may include: receiving, from a user, a request to access the secured system, wherein the request comprises a first authentication information and a second authentication information; authenticating, using a two-factor authentication practice, the user based on the first and second authentication information; in response to a positive authentication result, configuring a firewall gateway to allow access by the user to the secured system; and in response to a negative authentication result, configuring the firewall gateway to prevent access by the user to the secured system. In some examples, the infrastructure operating environment may include a critical infrastructure operating environment.

In some examples, the request from the user may be received through a virtual private network. The virtual private network may be one of a point-to-point tunneling protocol (PPTP), layer 2 tunneling protocol (L2TP), secure sockets layer (SSL), and Internet Protocol security (IP Sec) virtual private network.

In some examples, the first authentication information may include a login identification and a password, and the second authentication information may include a passcode generated from a nondeterministic random sequence of numbers.

In some examples, at least a portion of the two-factor authentication practice may be performed using an active directory or lightweight directory access protocol authentication server.

In some examples, the firewall gateway may provide access control between the virtual private network and the secured system. The firewall gateway may be a firewall of the secured system.

In some examples, the secured system may be associated with a utility, transportation, or oil and gas facility. The secured system may include one or more networked devices that are incapable of implementing access control and/or incapable of implementing two-factor authentication.

Systems and computer-readable storage medium for performing the methods are also provided.

### BRIEF DESCRIPTION OF THE FIGURES

FIG. 1 illustrates an exemplary authentication system for providing two-factor authentication to systems capable of implementing varying levels of access control according to various examples.

FIG. 2 illustrates another exemplary authentication system for providing two-factor authentication to systems capable of implementing varying levels of access control according to various examples.

FIG. 3 illustrates an exemplary process for providing two-factor authentication to systems capable of implementing varying levels of access control according to various examples.

FIG. 4 illustrates an exemplary computing system.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below relating to authentication systems and processes for providing two-factor authentication to systems capable of implementing varying levels of access control. In one example, the system may include an authentication and access control system that selectively grants access to a secured system or network. The authentication and access control system may implement a two-factor authentication routine and may configure a firewall gateway to grant or deny access to the secured system or network based on the results of the two-factor authentication. A user may connect to the authentication and access control system via a virtual private network (VPN). By separating the user from the secured system or network, the authentication and access control system can provide two-factor authentication for the secured system regardless of the secured system's own cyber security capabilities. This is particularly useful for legacy systems that are incapable of implementing a more sophisticated access control protocol, such as two-factor authentication.

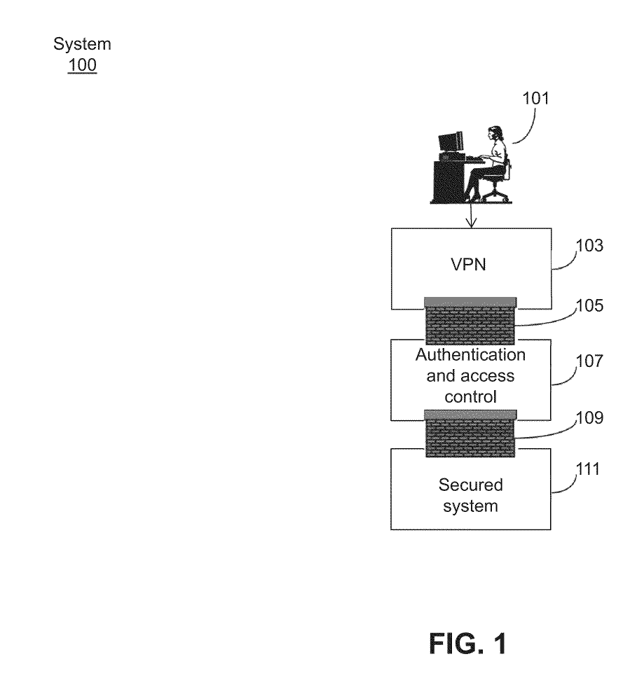

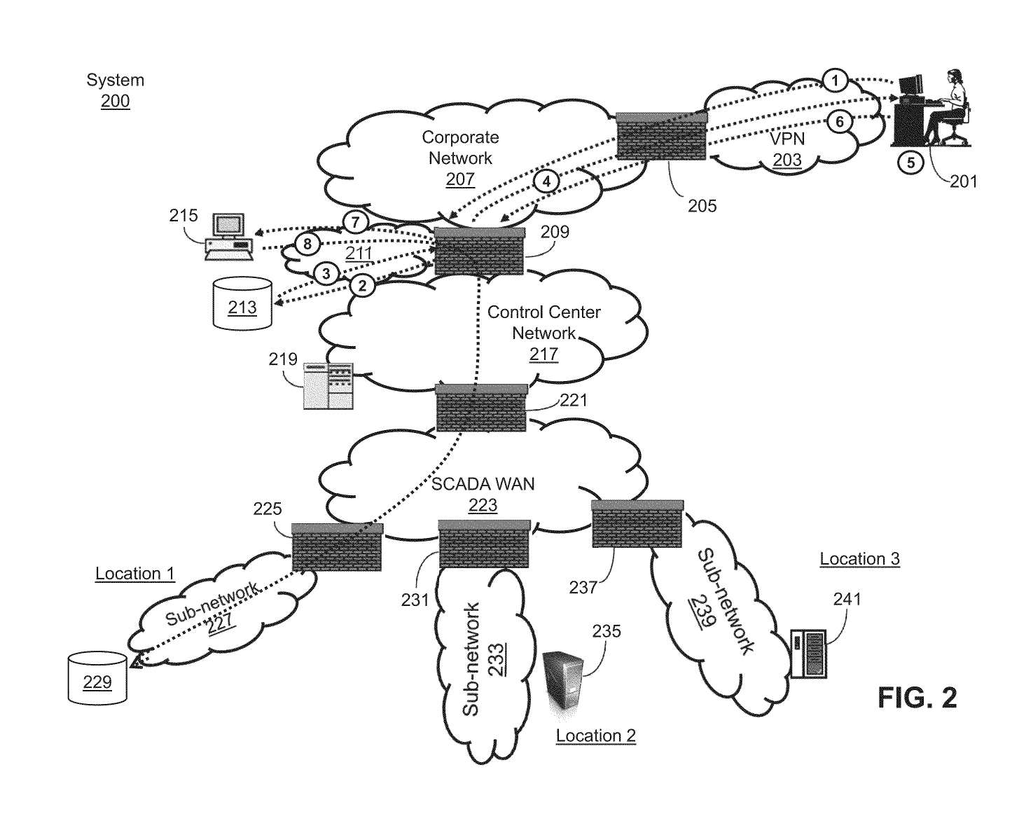

FIG. 1 illustrates a block diagram of exemplary authentication system 100 for providing two-factor authentication to systems capable of implementing varying levels of access control according to various examples. System 100 generally includes user 101 attempting to remotely access a secured system 111. On its own, secured system 111 may be capable of implementing any of various levels of cyber security and access control. For example, secured system 111 may be capable of implementing no access control, fixed user ID and/or fixed password, single factor user ID and password control, or the like. As mentioned above, these more primitive types of access control are characteristic of systems in the infrastructure industries, as many of the assets contained in these systems are relatively old devices that cannot implement more sophisticated access control protocols. Thus, to provide enhanced cyber security, system 100 may include authentication and access control system 107 for selectively granting and denying access to secured system 111 by user 101. In some examples, authentication and access control system 107 may implement two-factor authentication and may configure firewall 109 to either allow or deny access to secure system 111 by user 101. System 100 may further include an internet-based VPN 103 and firewall 105 for allowing user 101 to couple to authentication and access control system 107. A more detailed description of system 100 will now be provided with reference to FIG. 2, showing a more detailed view of an example of authentication system 100.

FIG. 2 illustrates exemplary authentication system 200 that can be used to implement authentication system 100 shown in FIG. 1. Similar to system 100, system 200 may include one or more users 201 operating a computing device, such as a desktop computer, laptop computer, tablet computer, mobile phone, or the like. Using their respective computing devices, the one or more users 201 may attempt to access a secure network, such as the network including networks 217, 223, 227, 233, and 239, in order to access remote cyber assets, such as cyber assets 219, 229, 235, and 241, located at Control Center Network, Locations 1, 2, and 3, respectively. The cyber assets may include any type of electronic device capable of being accessed through a network, such as a computer, database, industrial equipment, and the like. For example, when system 200 is implemented with an electric generation facility, the cyber assets may include supervisory control and data acquisition (SCADA) Control System Computer at the Control Room, Remote Terminal Units (RTU), Intelligent Electronic Devices (IED), or protection relays at one or more substations. However, it should be appreciated that the cyber assets can include any type of networked device that a user may attempt to access. Additionally, while each location includes a different type of cyber asset, it should be appreciated that each location may include one or more cyber assets of the same or a different type.

System 200 may further include an internet-based VPN 203 for allowing user 201 to couple to corporate network 207. Corporate network 207 may include any type of private network that may be owned and operated by the entity that owns and operates the secure network (e.g., networks 217, 227, 233, and 239). In some examples, corporate network 207 may be protected from VPN 203 by firewall 205. Various types of VPNs can be used, such as point-to-point tunneling protocol (PPTP), layer 2 tunneling protocol (L2TP), secure sockets layer (SSL), and Internet Protocol security (IP Sec).

System 200 may further include an authentication and access control system for providing access control to the secure network (e.g., networks 217, 223, 227, 233, and 239). For example, system 200 may include a perimeter network, or DMZ network 211, separated from corporate network 207 by a firewall function of Unified Threat Management (UTM) device 209. DMZ network 211 may include an active directory (AD) or lightweight directory access protocol (LDAP) authentication server 213 and a computing device or function 215 for authenticating user 201 using a two-factor authentication routine. In some examples, UTM device 209 and/or DMZ network 211 and its associated components may be capable of configuring the firewall function of UTM device 209 to selectively grant or deny access to the secured network (e.g., networks 217, 223, 227, 233, and 239) or specific cyber assets within the networks (e.g. 219,229, 235, and 241) by user 201. While DMZ network 211 is shown in FIG. 2 as being separate from corporate network 207, it should be appreciated that, in other examples, DMZ network 211 and its associated components may be incorporated into corporate network 207. Additionally, in some examples, the computing device or function 215 may be integrated into UTM device 209.

As mentioned above, system 200 may further include control center network 217 separated from DMZ network 211 and corporate network 207 by the firewall function of UTM device 209. Control center network 217 may include a private network that is access controlled by UTM device 209 and DMZ network 211 and its associated components. In some examples, control center network 217 may be a private network for the Operating environment of an infrastructure industry or critical infrastructure industry, such as a utility, transportation, oil and gas, or other industry. In these examples, control center network 217 may include a supervisory control and data acquisition (SCADA) system 219 for monitoring and controlling industrial devices and systems. For example, SCADA system 219 may be configured to manage SCADA wide area network (WAN) 223 including sub-networks 227, 233, and 239. Sub-networks 227, 233, and 239 may include various sub-networks of the infrastructure industry and the associating assets inside the sub-networks. For example, when system 200 is implemented with an electric generation facility, sub-networks 227, 233, and 239 may include substation networks that each communicatively couple together cyber assets at their respective locations.

System 200 may further include firewall 221 separating control center network 217 and SCADA WAN 223. In some examples, system 200 may further include firewalls 225, 231, and 237 separating SCADA WAN 223 from sub-networks 227, 233, and 239, respectively.

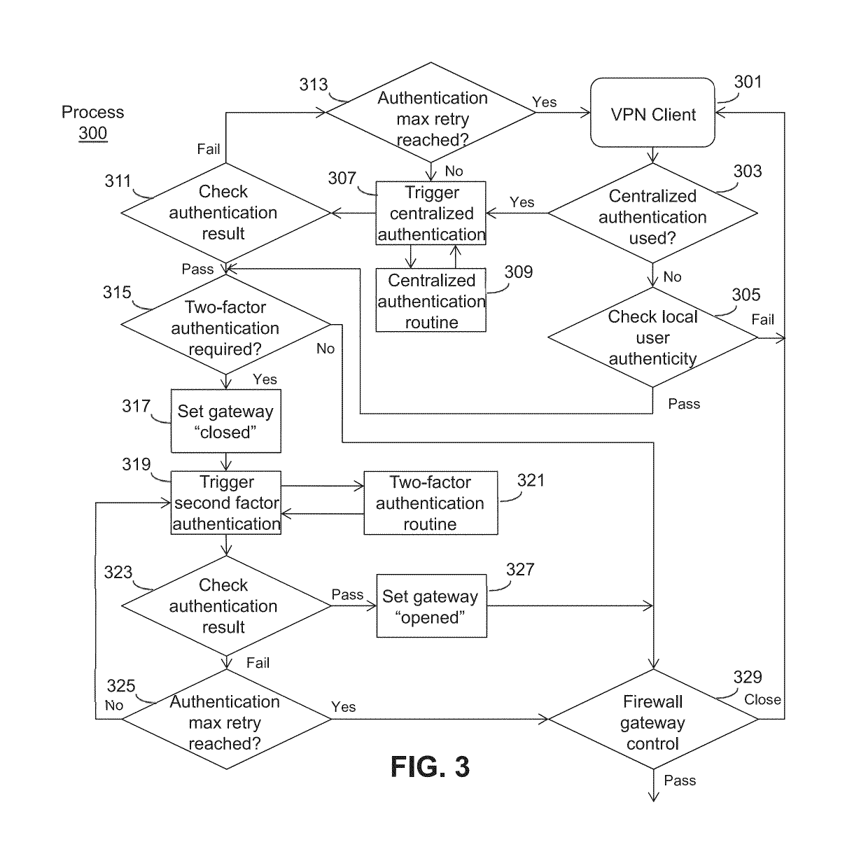

FIG. 3 illustrates an exemplary process 300 for providing two-factor authentication for a secure system according to various examples. As described in greater detail below, process 300 may be performed by various components of systems 100 and 200. As such, process 300 will be described below with reference to system 200 shown in FIG. 2.

At block 301 a user may attempt to access the operating network using a VPN client. For example, user 201 of FIG. 2 may attempt to access corporate network 207 and Control Center Network 217 via an internet-based VPN 203. Using a VPN IP addressing scheme, a session for user 201 may be port forwarded to UTM device 209 where the user's identity and password may be verified to grant access, as indicated by the dotted line numbered “1” in FIG. 2.

At block 303, it can be determined whether a centralized user authentication system is being used. For example, based on the user ID and password provided by user 201, UTM device 209 can determine whether a centralized user authentication system is used for this particular user. In some examples, a database can be used to store information identifying the type of authentication to be used for various users. Additionally, in some examples, the type of authentication can be based at least in part on the type of access being requested and/or the asset being accessed. Alternatively, in some examples where centralized authentication is always used, block 303 can be skipped and the process can instead proceed from block 301 to block 307.

If, at block 303, it is determined that a centralized authentication system is not used, the process may proceed to block 305. At block 305, a local user authentication routine can be performed. For example, UTM device 209 can reference a local database to determine whether the credentials provided by the user at block 301 are valid.

If, at block 305, it is determined that the credentials provided by the user at block 301 are not valid, the process may return to block 301 where the user may be prompted to reenter his/her credentials to gain access to the secured network. For example, if UTM device 209 determines that the credentials provided by user 201 are invalid, user 201 may be blocked from the corporate network 207 by firewall 205. User 201 may then again attempt to access corporate network 207 using the VPN client. This may require the user to reenter his/her login credentials.

If, however, at block 305, it is determined that the credentials provided by the user at block 301 are valid, the process may proceed to block 315. For example, UTM device 209 may determine, based on a comparison with records stored in a local database, that the credentials provided by user 201 are valid.

Returning now to block 303, if it is instead determined that a central user authentication system is being used, the process may proceed to block 307. For example, if, based on the login credentials provided by user 201, UTM device 209 determines that a central user authentication system is to be used for user 201, the process may proceed to block 307.

At block 307, a centralized authentication routine can be triggered by forwarding the user's login credentials to be processed by a centralized authentication routine at block 309. Various types of authentication routines, such as an AD or LDAP type routine, can be used to authenticate the user. For example, UTM device 209 may forward the credentials provided by user 201 to DMZ network 211, as indicated by the dotted line numbered “2” in FIG. 2. In particular, the credentials provided by user 201 may be forwarded to an authentication server 213 via DMZ network 211. As mentioned above, authentication server 213 may perform an AD or LDAP type authentication routine. The results of the centralized authentication routine can be returned to UTM device 209, as indicated by the dotted line numbered “3” in FIG. 2. While two example routines have been provided, it should be appreciated that other authentication routines known to those of ordinary skill in the art can be used as a centralized user authentication routine.

After performing the centralized user authentication at blocks 307 and 309, the process may proceed to block 311. At block 311, the results of the centralized user authentication can be checked. For example, UTM device 209 may check the results of the centralized user authentication performed by the authentication server 213.

If, at block 311, it is determined that the user failed the centralized user authentication performed at blocks 307 and 309, the process may proceed to block 313. At block 313, it can be determined whether a maximum number of centralized authentication attempts have been made. If the maximum number of attempts has been made, the user may be blocked from control center network 217 by UTM device 209 and the process may return to block 301. If, however, the maximum number of attempts has not been reached, then the process may proceed to block 307 where the user may be prompted again for login credentials. For example, if UTM device 209 determines that user 201 failed the centralized authentication routine performed by authentication server 213, UTM device 209 may determine if a maximum number of login attempts have been made. The maximum number of attempts can be selected to be any value depending on the preference of the system administrator. If UTM device 209 determines that the maximum number of authentication attempts has been reached, the user 201 may be blocked from accessing the operating networks. If, however, the maximum number of authentication attempts has not been reached, then user 201 may be prompted again for login credentials and the same centralized authentication process may be performed.

Returning to block 311, if it is instead determined that the user passed the centralized user authentication performed at blocks 307 and 309, the process may proceed to block 315. The process may also proceed to block 315 from block 305 if centralized authentication was not used and if the user passed the local authentication routine. At block 315, it can be determined if two-factor authentication is required. For example, UTM device 209 may determine whether or not two-factor authentication is required for user 201. Alternatively, in some examples, if two-factor authentication is always required, then block 315 can be skipped and the process can instead proceed from block 311 to block 317.

If, at block 315, it is determined that two-factor authentication is not required, the process can proceed to block 329 where the settings of a firewall to selectively grant or deny access to the secure system by the user may be configured based on the firewall variable “gateway” that is initially set to “open.” In this example, since the “gateway” variable was not changed to “closed,” at block 329, the firewall gateway may be configured to grant access to the user to the secure system. For example, if it is determined by UTM device 209 that two-factor authentication is not required, then UTM device 209 may configure its firewall function to allow access to user 201 to the secured network (e.g., networks 217, 223, 227, 233, and 239).

If, however, it is determined that two-factor authentication is required at block 315, the process may proceed to block 317 where the firewall variable “gateway” is set to “closed.” This variable may be used at block 329 to configure the settings of a firewall to selectively grant or deny access to the secure system by the user. While a specific “gateway” variable name and a specific “closed” variable value are provided, it should be appreciated that any variable name and value can be used to obtain a similar result. In some examples, if it is determined by the UTM device 209 that two-factor authentication is required, then the computing device may set “gateway” variable to “closed.”

After setting the “gateway” variable to “closed,” the process can proceed to block 319 where the two-factor authentication can be triggered by prompting the user for the second-factor information. The second factor information can be any type of information that is different than the already provided credentials. In some examples, the second factor information may include a numerical passcode generated from a nondeterministic random sequence (e.g., from a keyfob or an application running on a mobile device). For example, UTM device 209 may prompt user 201 for the second factor information, as indicated by the dotted line numbered “4” in FIG. 2. User 201 may enter the second factor information (e.g., from a keyfob or an application running on a mobile device), as indicated by the number “5” in FIG. 2.

Once the second-factor information is received, the second factor authentication routine can be performed at block 321. Various types of two-factor authentication routines known to those of ordinary skill in the art can be used. For example, UTM device 209 may receive the second factor information from user 201, as indicated by the dotted line numbered “6” in FIG. 2. UTM device 209 may then forward the second factor information to a computing device 215 via DMZ network 211, as indicated by the dotted line numbered “7” in FIG. 2. Computing device 215 may include software for performing the second portion of the two-factor authentication. In some examples, computing device 215 may be integrated within UTM device 209 while, in other examples, computing device 215 may be separate from UTM device 209.

After performing the second portion of the two-factor authentication routine at blocks 319 and 321, the process may proceed to block 323. At block 323, the results of the second portion of the two-factor authentication can be checked. If, at block 323, it is determined that the user failed the second portion of the two-factor authentication routine performed at blocks 319 and 321, the process may proceed to block 325. At block 325, it can be determined whether a maximum number of two-factor authentication attempts have been made. If the maximum number of attempts have been reached, the user may proceed to block 329 where the firewall may be configured based on the value of the “gateway” variable set at block 317 or 327. The process may then return to block 301, where the entire authentication procedure may be performed from the start.

If, however, the maximum number of attempts has not been reached, then the process may return to block 319 where the user may be prompted again for the second factor information. For example, if computing device 215 determines that user 201 failed the second portion of the two-factor authentication routine, UTM device 209 may determine if a maximum number two-factor authentication attempts have been made. The maximum number of attempts can be selected to be any value depending on the preference of the system administrator. If UTM device 209 determines that the maximum number of authentication attempts has been reached, it will block user 201 from accessing the secured network (e.g., networks 217, 223, 227, 233, and 239) using its firewall function since the value of the “gateway” variable was set to “closed” at block 317. If, however, the maximum number of authentication attempts has not been reached, then user 201 may be prompted again for second factor information and the same two-factor authentication process may be performed.

Returning to block 323, if it is instead determined that the user passed the second portion of the two-factor authentication performed at blocks 319 and 321, the process may proceed to block 327. At block 327, the “gateway” variable may be set to “opened.” For example, computing device 215 may set the “gateway” variable may be set to “opened” if it is determined that user 201 provided valid second factor information.

After setting the “gateway” variable to “opened,” the process may then proceed to block 329 where the firewall function of UTM device 209 may be configured based on the value of the “gateway” variable set at block 317 or 327. In this example, the firewall may be configured to allow the user to access the protected network since the “gateway” variable was changed from “closed” to “opened” at block 327. The user may now have access to the secured system and any associated desired cyber assets. For example, upon passing the two factor authentication, UTM device 209 may provide user 201 with access through its firewall to the secured network (e.g., networks 217, 223, 227, 233, and 239) since the value of the “gateway” variable was changed from “closed” to “opened” at block 327. Now that user 201 has access to control center network 217, user 201 may communicate with SCADA system 219 to gain access to cyber asset 229, 235, or 241 via the SCADA WAN 223. In particular, the computing device of user 201 may communicate with SCADA system 219 to gain access to SCADA WAN 223 via firewall 221 and to gain access to a sub-network (e.g., sub-network 227) containing a desired cyber asset (e.g., cyber asset 229) via an appropriate firewall (e.g., firewall 225), as indicated by the dotted line numbered “8” in FIG. 2.

By including an authentication and access control system between a user and a secured system or network, additional security can be provided to the secured system or network that may otherwise be incapable of implementing such a level of cyber security. In this way, the authentication and access control system can be incorporated into existing systems, such as systems for infrastructure industries, regardless of their independent cyber security capabilities.

While the examples above were described with respect to systems for infrastructure in the utility industries, it should be appreciated that the systems and processes can similarly be applied to other infrastructure industries. Additionally, in some examples, the systems and processes disclosed herein may be particularly useful in critical infrastructure industries, such as oil and gas, waterworks, transportation, and the like.

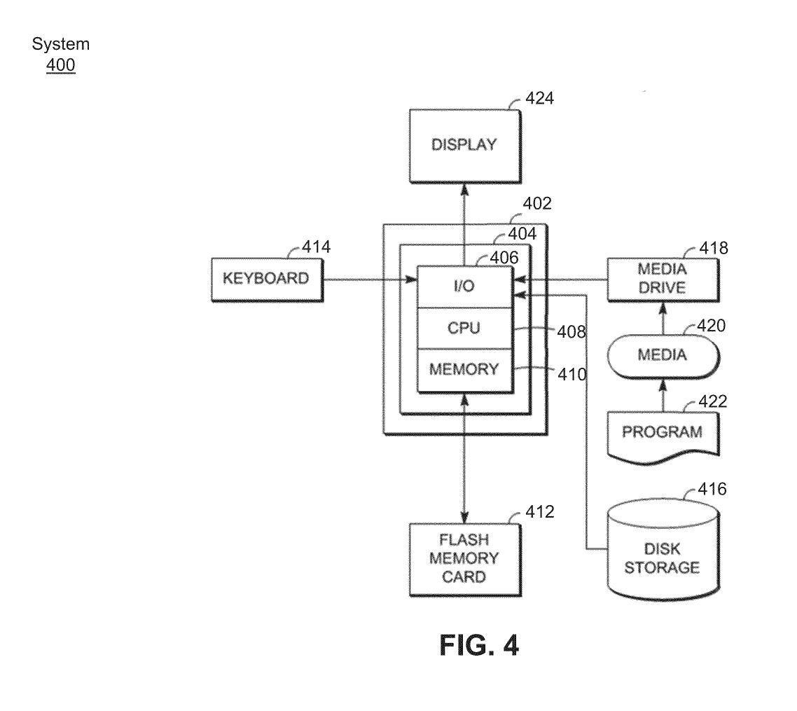

FIG. 4 depicts an exemplary computing system 400 that can be used by any of the computing devices of system 100 or 200 to perform some or all of process 300. In this context, computing system 400 may include, for example, a processor, memory, storage, and input/output devices (e.g., monitor, keyboard, disk drive, Internet connection, etc.). However, computing system 400 may include circuitry or other specialized hardware for carrying out some or all aspects of the process. In some operational settings, computing system 400 may be configured as a system that includes one or more units, each of which is configured to carry out some aspects of the processes either in software, hardware, or some combination thereof.

FIG. 4 depicts an exemplary computing system 400 with a number of components that may be used to perform the above-described process. The main system 402 includes a motherboard 404 having an input/output (“I/O”) section 406, one or more central processing units (“CPU”) 408, and a memory section 410, which may have a flash memory card 412 related to it. The I/O section 406 is connected to a display 424, a keyboard 414, a disk storage unit 416, and a media drive unit 418. The media drive unit 418 can read/write a computer-readable medium 420, which can contain programs 422 or data.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general purpose programming language (e.g., Pascal, C, C++) or some specialized application-specific language.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this disclosure.

What is claimed is:

1. A computer-implemented method for providing two-factor authentication for a secured system in an infrastructure operating environment, the method comprising:
i. receiving, from a user, a request to access the secured system, wherein the request comprises a first authentication information and a second authentication information;
ii. authenticating, using a two-factor authentication protocol, the user based on the first and second authentication information;
iii. in response to a positive authentication result, configuring a firewall gateway to allow access by the user to the secured system; and
iv. in response to a negative authentication result, configuring the firewall gateway to prevent access by the user to the secured system.

2. The computer-implemented method of claim 1, wherein the request from the user is received through a virtual private network.

3. The computer-implemented method of claim 2, wherein the firewall gateway provides access control between the virtual private network and the secured system.

4. The computer-implemented method of claim 2, wherein the virtual private network is one of a point-to-point tunneling protocol (PPTP), layer 2 tunneling protocol (L2TP), secure sockets layer (SSL), and Internet Protocol security (IP Sec) virtual private network.

5. The computer-implemented method of claim 1, wherein at least a portion of the two-factor authentication protocol is performed using an active directory or lightweight directory access protocol authentication server.

6. The computer-implemented method of claim 1, wherein the first authentication information comprises a login identification and a password.

7. The computer-implemented method of claim 1, wherein the second authentication information comprises a passcode generated from a nondeterministic random sequence of numbers.

8. The computer-implemented method of claim 1, wherein the secured system is associated with a utility, transportation, or oil and gas facility.

9. The computer-implemented method of claim 1, wherein the secured system comprises one or more networked devices that are incapable of implementing access control.

10. The computer-implemented method of claim 1, wherein the secured system comprises one or more networked devices that are incapable of implementing two-factor authentication.

11. The computer-implemented method of claim 1, wherein the firewall gateway is a firewall of the secured system.

12. A system for providing two-factor authentication to a secured system in an infrastructure operating environment, the system comprising:
one or more electronic assets; and
a unified threat management device for controlling access to the one or more electronic assets, wherein the unified threat management device is configured to:
receive, from a user, a request to access an electronic asset of the one or more electronic assets, wherein the request comprises a first authentication information and a second authentication information;
authenticate, using a two-factor authentication protocol, the user based on the first and second authentication information;
in response to a positive authentication result, configure a firewall gateway to allow access by the user to the electronic asset of the one or more electronic assets; and
in response to a negative authentication result, configure the firewall gateway to prevent access by the user to the electronic asset of the one or more electronic assets.

13. The system of claim 12, wherein the request from the user is received through a virtual private network.

14. The system of claim 13, wherein the firewall gateway provides access control between the virtual private network and the one or more electronic assets.

15. The system of claim 12 further comprising an active directory or lightweight directory access protocol authentication server, wherein at least a portion of the two-factor authentication protocol is performed using the active directory or lightweight directory access protocol authentication server.

16. The system of claim 12, wherein the one or more electronic assets are associated with a utility, transportation, or oil and gas facility.

17. The system of claim 16, wherein the one or more assets comprise one or more of a supervisory control and data acquisition (SCADA) Control System Computer, Remote Terminal Unit (RTU), Intelligent Electronic Devices (IED), or a protection relay at a substation.

18. The system of claim 12, wherein the secured system comprises one or more networked devices that are incapable of implementing access control.

19. The system of claim 12, wherein the secured system comprises one or more networked devices that are incapable of implementing two-factor authentication.

20. The system of claim 12, wherein the firewall gateway is a firewall function of the unified threat management device.

21. A non-transitory computer-readable storage medium comprising program code for providing two-factor authentication for a secured system in an infrastructure operating environment, the program code for:
i. receiving, from a user, a request to access the secured system, wherein the request comprises a first authentication information and a second authentication information;
ii. authenticating, using a two-factor authentication protocol, the user based on the first and second authentication information;
iii. in response to a positive authentication result, configuring a firewall gateway to allow access by the user to the secured system; and
iv. in response to a negative authentication result, configuring the firewall gateway to prevent access by the user to the secured system.

22. The non-transitory computer-readable storage medium of claim 21, wherein the request from the user is received through a virtual private network.

23. The non-transitory computer-readable storage medium of claim 22, wherein the firewall gateway provides access control between the virtual private network and the secured system.

24. The non-transitory computer-readable storage medium of claim 21, wherein the secured system is associated with a utility, transportation, or oil and gas facility.

25. The non-transitory computer-readable storage medium of claim 21, wherein the secured system comprises one or more networked devices that are incapable of implementing two-factor authentication.

26. The computer-implemented method of claim 21, wherein the firewall gateway is a firewall of the secured, system.
